(19) United States
(12) Patent Application Publication
(10) Pub. No.: US 2007/0259551 A1
(43) Pub. Date: Nov. 8, 2007

(54) Dual-hook locking assembly

(75) Inventors: Jacob Rebel, Abbotsford (CA); Kai Zhang, Langley (CA); Hong Chen, Surrey (CA)

Correspondence Address: FREDERICK KAUFMAN, SUITE #403, 1937 PENDRELL STREET, VANCOUVER, V6G IT4, CA

(73) Assignee: VANGUARD PLASTICS LTD.

(21) Appl. No.: 11/824,752

(22) Filed: Jul. 3, 2007

(51) Int. Cl. H01R 13/15

(52) U.S. Cl. 439/260

(57) ABSTRACT

A dual-hook locking assembly mounted in a casing subassembly is actuated from outside of the latter by a handle which causes a locking subassembly to operate between an unlocked and a locked position. By rotating the driving handle, a gearing subassembly including a pair of meshed segmental gears drives the locking subassembly between the aforementioned positions. The gearing subassembly and the locking subassembly are directly interconnected. An adjusting subassembly is used for positioning the locking subassembly with respect to a strike plate of a door. The adjusting subassembly comprises several guiding plates. The latter and the gearing subassembly have a common center of rotation.

### I. BACKGROUND OF THE INVENTION

1. Technical Field

The present invention relates in general to locking assemblies and, in particular, to a dual-hook locking assembly.

2. Description of the Prior Art

To keep pace with continuous advances in home building and in order to comply with the requirements to enhance the security of existing homes and flats, the need to develop new, improved locking assemblies became a pressing reality. Consequently, attempts have been made to develop compact and reliable dual-hook assemblies, which, in comparison with one hook locking assemblies, provide enhanced security. An example of such an attempt is U.S. Pat. No. 6,776,441, granted on Aug. 17, 2004 to Liu for a “Lock Assembly with Two Hook Devices”. This patent comprises a casing, a pivotable member rotatably mounted in the casing, two linking rods, each having a first and a second end, the first end being rotatably connected to the pivotable member, and two hook devices, each including a first hook member and a second hook member. Each second hook member is pivotally mounted in the casing. The second end of each linking rod is pivotally connected to an associated second hook member. Each hook member further includes a hooked second end that is passable through an associated opening of the casing. As can be seen, the described hook assembly uses between the driving component/pivotable member/and the driven component/second hooked end of each first hook member/a transmission structure consisting of links rods, and each second hook member is as pivotable member rotatably mounted in the casing. Hence, this assembly lacks compactness, while the use of an interposed transmission negatively affects the assembly's reliability. Another example is U.S. Pat. No. 7,040,671, granted on May 9, 2006 to Liu for a “Lock Assembly with Two Hook Devices”. This patent discloses a lock assembly including a casing, two pivotable members rotatably mounted in the casing and meshed with each other, two linking rods, and two hook devices, each including a hook member and a rocker arm that is pivotally mounted in the casing. Each hook member has a first end pivotally connected to an associated rocker arm and a hooked second end that is passable through an associated one of two openings of the casing. When either pivotable member is rotated, each rocker arm and each hook member are actuated such that the hooked second end of each hook member is moved between a retracted position in the casing and a locking position out of the casing. As can be inferred from the above description of U.S. Pat. No. 7,040,671, the components of the latter are basically common, except two pivotable members rotatably mounted in the casing and meshed with each other, with those described in U.S. Pat. No. 6,776,441. As a corollary of this similarity, it is obvious that the shortcomings of the latter patent, as stated above, also apply to U.S. Pat. No. 7,040,671.

### II. SUMMARY OF THE INVENTION

Taking in account the mentioned drawbacks, in the designing of an improved dual-hook locking assembly according to the present invention, the main aimed objective has been to reduce to a minimum the number of components of the locking assembly, such as articulated links and those components which require pivoting supports.

Broadly stated, the dual-hook locking assembly according to the present invention comprises a subassembly for housing wherein are mounted: a gearing subassembly for operating, a subassembly for locking, operated between a locked position and an unlocked position by the gearing subassembly for operating, and a subassembly for adjusting subassembly for locking in a convenient position with respect to a strike plate.

The subassembly for housing comprises an elongated housing and a closing plate, the former and the latter being assembled together.

The gearing subassembly for operating includes a pair of pivoting bodies, each one of the latter incorporating a segmental gear. An actuation of one of the pivoting bodies transmits a rotation via its segmental gear to the other segmental gear, the former meshing with the latter. Each one the pivoting bodies incorporate as well a tail element situated in a zone adjacent to the segmental gear and provided with a perpendicular opening for insertion of a connecting feature.

The subassembly for locking comprises a pair of hook mechanisms, an upper and lower structurally identical hook mechanisms. Each of the latter has an outwardly extending hook section, a middle section and an inwardly extending connecting section extending towards the transversal axis of symmetry of the subassembly for housing. The inwardly extending connecting section includes a contacting lobe and a hole, located in a zone adjacent to the latter, the latter being positioned for coinciding with the perpendicular opening for insertion, through which the connection feature is inserted. Thus, a direct pivoting interconnection between each gearing subassembly for operating, respectively each tail element of each pivoting body, and the subassembly for locking, is established. Each of the latter has an aperture in its middle section penetrated by a pin protruding outwardly beyond the subassembly for locking as adjusting butts.

At least one tension springy element for connecting the hook mechanisms via an anchor-cam wall is used. The latter is coplanar with the transversal axis of symmetry and is disposed perpendicularly to a central front wall of the elongated housing. At least one helical tension spring for connecting the hook mechanisms develops a return force from its extended position when the hook mechanisms are in their latching position, and resiliently keep the hook mechanisms when they are in retracted, unlocked position. The subassembly for adjusting the subassembly for locking in a convenient position with respect to a strike plate includes two pairs of guiding plates, each pair of the latter being able to turn with its inwardly extending ends around one of the pivoting bodies and interact with one of the hook mechanisms, while its outwardly extending ends are associated with an adjusting bolt-nut.

In one aspect of this invention, for anti-slam protection the elongated housing is provided with two stop lugs (an upper and a lower), struck from a lateral main wall of the elongated housing, inclined with respect to the transversal axis of symmetry and disposed somewhat closer to a back wall. One stop lug is situated in the proximity of a top wall, while the other one—in proximity of a bottom wall. The pair of hook mechanisms are provided with middle sections. During a slamming of a door the middle sections press against and are stopped by the stop lugs; one of the stop lugs, the upper one, imparts essentially a translation combined with rotation resulting in a force directed towards the transversal axis of symmetry to one of the hook mechanisms (the upper one), and/or another one of the stop lugs (the lower one) imparts essentially a translation combined with rotation resulting in a force directed towards the transversal axis of symmetry to one of the hook mechanisms (the lower one).

### III. BRIEF DESCRIPTION OF THE DRAWINGS

Although the characteristic features of the invention will be particularly pointed out in the claims, the invention itself and the manner in which it may be made and used may be better understood by referring to the following description and accompanying drawings. Like reference numerals refer to like parts throughout the several views of the drawings in which:

FIG. 1 is a side elevation view of the present invention, illustrating the dual-hook locking assembly in an unlocked state;

FIG. 2 is a view similar to FIG. 1, wherein the dual-hook locking assembly is in a locked state;

FIG. 3 shows an exploded perspective view of the dual-hook locking assembly in accordance with the present invention;

FIG. 4 shows a perspective view of the elongated housing, which constitutes the main component of the casing subassembly;

FIG. 5 shows a perspective view of the closing plate, the other component of the casing subassembly;

FIG. 6 is a perspective of an upper pivoting body, viewed from the front;

FIG. 7 is a perspective of the upper pivoting body of FIG. 6, viewed from the back;

FIG. 8 shows an exploded perspective view of a hook mechanism; and

FIG. 9 is a perspective view of one of the guiding plates of the adjusting subassembly.

### IV. DESCRIPTION OF THE PREFERRED EMBODIMENT

As can be seen from the accompanying drawings, a dual-hook locking assembly according to the present invention is generally identified by reference number 10.

It is to be agreed, that terms such as “vertical”, “horizontal”, “upper”, “lower”, “inward”, “upward”, “downward”, “front”, “back”, “lateral”, “top”, “bottom” are conventionally employed in the present specification with reference to a usual position in a door in which locking assembly 10 will be generally used.

Dual-hook locking assembly 10 comprises:
a casing subassembly 100;
a gearing subassembly 200;
a locking subassembly 300; and
an adjusting subassembly 400,

gearing, locking and adjusting subassemblies 200, 300 and 400 are all located in casing subassembly 100 and are generally used as follows:
casing subassembly 100 for housing all other aforementioned subassemblies;
gearing subassembly 200 for operating
locking subassembly 300 between a locked position and an unlocked position; and
adjusting subassembly 400 for conveniently positioning the latter with respect to a strike plate S used for interconnecting with dual-hook locking subassembly 10.

Casing subassembly 100 comprises an elongated housing 102 and a closing plate 150. The former and the latter are usually formed by stamping and assembled together by threaded elements or by snapping. It is obvious that other known manufacturing methods could substitute the stamping method of fabrication.

Elongated housing 102 is basically defined by a transversal axis of symmetry 104 and includes a lateral main wall 106 which extends into front 108 and back 110 walls and into top 112 and bottom 114 walls.

Lateral main wall 106 incorporates two guiding openings 116, identical, vertically aligned and equally spaced from transversal axis of symmetry 104. Lateral main wall 106 further incorporates two attachment openings 118, identical, vertically aligned and disposed asymmetrically with respect to transversal axis of symmetry 104. One of the two attachment openings 118 is somewhat spaced from top wall 112, while the other one is relatively closer to bottom wall 114 of lateral main wall 106. Two threaded blind sleeves 120, disposed coaxially with attachment openings 118, extend horizontally and inwardly from lateral main wall 106, to which they are permanently secured. Two mounting openings 121 used for attachment to a window or door profile (both not shown), one being closer to top wall 112 while the other one relatively spaced from bottom wall 114, alternate with the two threaded blind sleeves 120.

Two stop lugs 122 (an upper and a lower), struck from lateral main wall 106, are inclined with respect to transversal axis of symmetry 104 and disposed somewhat closer to back wall 110; one stop lug 122 being situated in the proximity of top wall 112, while the other one—in the proximity of bottom wall 114.

Two engaging lugs 124, bent from lateral main wall 106, are perpendicularly disposed with respect to transversal axis of symmetry 104, at each side of and proximate to the latter. The two engaging lugs 124 are somewhat inwardly retracted from a vertical plane passing through back wall 110.

Front wall 108 comprises a central front wall 108a that perpendicularly and centrally projects from the front of lateral main wall 106, from which it is bent. The former is also perpendicular to transversal axis of symmetry 104. A central rectangular protrusion 108b, relatively much smaller than central front wall 108a, the former and the latter being coplanar, extends from the latter. An anchor-cam wall 108c, coplanar with transversal axis of symmetry 104, is disposed perpendicularly to central front wall 108a (a gap, not shown, being established between anchor-cam wall 108c and the latter) and is provided with an aperture 108d. Furthermore, front wall 108 comprises, starting from each of its longitudinal extremities, a pair of front wall ends 108e, each of the latter being provided with a hole 108f. Front wall 108 includes between central front wall 108a and each front wall end 108e an open space 108h. Between each front wall end 108e and top 112 and bottom 114 walls, an interstice 108g is provided.

Back wall 110 comprises a central back wall 110a that perpendicularly and centrally projects out of the back of lateral main wall 106, from which it is bent. The former is also perpendicular to transversal axis of symmetry 104. A central rectangular extension 110b, relatively much smaller than central back wall 110a/the former and the latter being coplanar/, extends out from the latter.

Furthermore, back wall 110 includes, starting from each of its longitudinal extremities, a pair of back wall ends 110c located in the same vertical plane. Each back wall end 110c is provided with a central rectangular projection 110d. Back wall 110 further comprises between central back wall 110a and each back wall end 110c an empty space 110e. Central back wall 110a and back wall ends 110c are parallel, the former being somewhat protruded with respect to the latter.

Closing plate 150 of casing subassembly 100 includes a lateral base wall 150a that extends into a pair of perpendicularly bent and longitudinally opposite face walls 152.

Lateral base wall 150a is provided with a pair of first openings 150′ coaxial and commensurate with two guiding openings 116, with a pair of chamfered openings 150″ coaxial and commensurate with two threaded blind sleeves 120 and their attachment openings 118 and with a pair of second openings 150″′ coaxial and commensurate with two mounting openings 121. Furthermore, lateral base wall 150a is delimited by a frontal margin 150b, centrally provided with an indentation 150c, shaped and sized to enable an engagement with central rectangular protrusion 108b/when elongated housing 102 and closing plate 150 are assembled together/.

Perpendicularly bent and longitudinally opposite face walls 152 are somewhat retracted from a vertical plane which incorporates frontal margin 150b as to enable their insertion into interstices 108g, beneath the pair of front wall ends 108e/when elongated housing 102 and closing plate 150 are assembled together/.

Each perpendicularly bent and longitudinally opposite face wall 152 includes a guiding slot 150c corresponding to hole 108f and extends upwardly beyond top wall 112 and downwardly beyond bottom 114 wall, wherein a circular perforation 150d is made.

Lateral base wall 150a is delimited as well by a rear margin 150e which incorporates a central indented passage 150f, shaped and sized to enable the insertion of central rectangular extension 110b. Central indented passage 150f is flanked by a pair of protrusions 150g extending past rear margin 150e. Protrusions 150g match empty spaces 110e located between central back wall 110a and each back wall end 110c.

Complementarily to the above features with which a centering between elongated housing 102 and closing plate 150 is achieved, a fastening of the former and latter with screws 152 passing through chamfered openings 150″ and tightened into two threaded blind sleeves 120 is used. Alternatively, snapping can be used for fastening of elongated housing 102 and closing plate 150.

Uses of the different features of casing subassembly 100, not described above, are discussed in detail later in the present disclosure.

In more detail in terms of structure, gearing subassembly 200 includes a pair of pivoting bodies 205 (an upper and a lower) enabled to rotate in two guiding openings 116 provided in lateral main wall 106 of elongated housing 102 and in the pair of first openings 150′ provided in lateral base wall 150a of closing plate 150. A pivoting body 205 is structurally a unitary component and includes a stepped cylindrical shaft 205a having a median section 205b with a relatively larger diameter and, as well, a front section 205c and a back section 205d, both with a relatively lesser diameter. The front section 205c and back section 205d engage with a sliding fit two guiding openings 116 and, respectively, the pair of first openings 150′. A segmental gear 205e extends out from median section 205b of each stepped cylindrical shaft 205a. Two segmental gears 205e (an upper and a lower) mesh together, so that a rotation of either one of pivoting bodies 205 transmits a rotation to the other. A thickness of segmental gear is somewhat less than a length of median section 205b.

A tail element 205f, relatively thinner than segmental gear 205e and situated in a zone adjacent to the latter, extends from median section 205b. A cylindrical element 205g projects perpendicularly out from an extremity of tail element 205f and is provided with a perpendicular opening 205h that continues throughout the latter.

In each stepped cylindrical shaft 205a a longitudinal slot 205i is formed. The latter is adapted to be actuated by a handle (not shown).

Alternatively to the foregoing description of the pair of pivoting bodies 205 (an upper and a lower), wherein due to the shape and position of tail element 205f with respect to segmental gear 205e, the upper pivoting body differs from the lower pivoting body, one being the mirror image of the other one, a conveniently modified tail element 205f can render the pivoting bodies 205 identical.

Locking subassembly 300 includes an upper and lower hook mechanism 305, each of which comprising a pair of long external hook plates 310 and a pair of superimposed short internal hook plates 315, the latter being interposed between the former. Upper and lower hook mechanisms 305 being structurally identical are further called hook mechanisms 305.

A long external hook plate 310 incorporates an outwardly extending hook section 310a, a middle section 310b and an inwardly extending connecting section 310c extending towards transversal axis of symmetry 104 and including a contacting lobe 310d. Between outwardly extending hook section 310a and middle section 310b a recessed zone 310e is formed.

The pair of superimposed short internal hook plates 315 is so shaped and sized as to be sandwiched between and geometrically conform to outwardly extending hook sections 310a and to a part of middle sections 310b of the pair of long external hook plates 310.

Each long external plate 310 has, starting from outwardly extending hook section 310a downwardly, a first chamfered hole 310f, a second chamfered hole 310g, a relatively reduced diameter hole 310h, a conventional hole 310i, and then, from there, laterally towards contacting lobe 310d, a fourth chamfered hole 310j and a fifth chamfered hole 310k.

Each short internal hook plate 315 incorporates two corresponding holes 315a and 315b equal in size and coaxial with first and second chamfered holes 310f and 310g.

A stepped pin 320 is placed between long external plates 310 so that its shoulders abut against the latter, while its extremities pass through long external plates 310, namely opposed conventional holes 310i, and protrude outwardly beyond the latter in the form of adjusting butts 320b. Conveniently, a cylindrical pin can substitute stepped pin 320. The length of cylindrical pins is so chosen as to enable their ends to freely slide on opposed internal walls of casing subassembly 100.

A stepped rivet 325 is also placed between long external plates 310 so that its shoulders, when it is riveted, keep spaced the foregoing plates at the same distance as when the pair of superimposed short internal hook plates 315 is interposed between the pair of long external hook plates 310.

A first countersunk-head rivet 330, which passes through first chamfered holes 310f and corresponding holes 315a, attaches together the pair of long external hook plates 310 between which is sandwiched the pair of superimposed short internal hook plates 315. Furthermore, a second countersunk-head rivet 335, which passes through second chamfered holes 310g and corresponding holes 315b, attaches also together the pair of long external hook plates 310 and the pair of superimposed short internal hook plates 315.

An expandable split cylinder 340 is press fit into opposed relatively reduced diameter holes 310h provided in the pair of long external hook plates 310. Alternatively, a stepped pin can be conveniently used.

A connecting pin 345 for insertion through cylindrical element 205g that projects perpendicularly out of an extremity of tail element 205f, respectively through its perpendicular opening 205h which extends throughout the latter, and throughout the pair of long external hook plates 310, respectively through their fifth chamfered holes 310k, is used. Thus, a direct pivotable linkage/without the use of intermediary links/is established between gearing subassembly 200 and locking subassembly 300.

Optionally, to the above described hook mechanisms 305, a variant comprising a single unitary component substituting for a pair of long external hook plates 310 and a pair of superimposed short internal hook plates 315, the latter being interposed between the former, can be used.

A helical tension spring 350 terminating at each end with a spring hook 350a/made of one or more bent coil(s)/is used separately for upper and for lower hook mechanisms 305 of locking subassembly 300. Thus, one spring hook 350a is connected to anchor-cam wall 108c belonging to elongated housing 102, specifically via aperture 108d of the former, while an opposite spring hook 350a is connected to expandable split cylinder 340 comprised in upper and lower hook mechanisms 305.

Alternatively, instead of the use of a helical tension spring 350, separately for upper and for lower hook mechanisms 305 of locking subassembly 300, a variant using a single helical tension spring connecting expandable split cylinders 340 comprised in upper and lower hook mechanisms 305 and passing through the gap formed between central front wall 108a and anchor-cam wall 108c can be used.

Instead of helical tension spring 350, use can be made of another conveniently chosen biasing element.

Adjusting subassembly 400 comprises:
two pairs of guiding plates 405, one pair of the latter being used to interact with upper hook mechanism 305, while the other pair-with lower hook mechanism 305; and
a pair of adjusting bolt-nuts: 410 (bolt) and 415 (nut).

Each pivoting body 205 of gearing subassembly 200 together with its associated hook mechanism 305 are flanked by a pair of guiding plates 405 in contact with lateral main wall 106 of elongated housing 102 and, respectively, with lateral base wall 150a of closing plate 150.

A guiding plate 405 includes an inwardly extending end 405a (extending towards the transversal axis of symmetry 104) and an outwardly extending end 405b (away from transversal axis of symmetry 104). Inwardly extending end 405a is provided with a centering circular aperture 405c, the latter being concentric and commensurate with guiding opening 116 of lateral main wall 106 and, respectively, with first openings 150′ provided in lateral base wall 150a of closing plate 150. Outwardly extending end 405b includes a bifurcated section 405d.

Each guiding plate 405 is provided between inwardly extending end 405a and outwardly extending end 405b with a slope edge 405e followed by a cam edge 405f.

Each adjusting bolt 410 passes through hole 108f provided in a front wall end 108e of front wall 108 and then through guiding slot 150c provided in an opposite face wall 152 of closing plate 150. Adjusting bolt 410 is threaded into nut 415. The latter is easy-fit into bifurcated sections 405d of a pair of parallel-opposite guiding plates 405.

### Operation of Dual-Hook Locking Assembly 10

Gearing subassembly 200 operates locking assembly 300 in response to a rotation of a tail element of a driving handle (both not labeled) inserted into longitudinal slot 205i of either one of the pair of pivoting bodies 205.

Due to the fact that gearing subassembly 200 comprises a pair of pivoting bodies 205, each one of the latter incorporating a segmental gear 205e, an actuation of one the pivoting bodies 205f transmits the rotation via its segmental gear 205e to the other segmental gear 205e, the former meshing with the latter. Pivoting bodies 205 synchronously rotating cause a rotation accompanied by a translation of hook mechanisms 305 (the upper and the lower), with which they are respectively associated, between a locked position and an unlocked position.

In order to positionally adjust hook mechanisms 305 to obtain an appropriate locking, the latter are conveniently rotated around pivoting bodies 205. To this end, the pair of adjusting bolt-nut assemblies: 410 (bolt) and 415 (nut) are so positioned that during the locking operation a continuous engagement between stepped pin 320 and cam edge 405f occurs, so that the extreme position of outwardly extending hook sections 310a is limited.

Helical tension springs 350 develop a return force from their extended position when hook mechanisms 305 are in their latching position, and resiliently keep hook mechanisms 305 when they are in retracted, unlocked position.

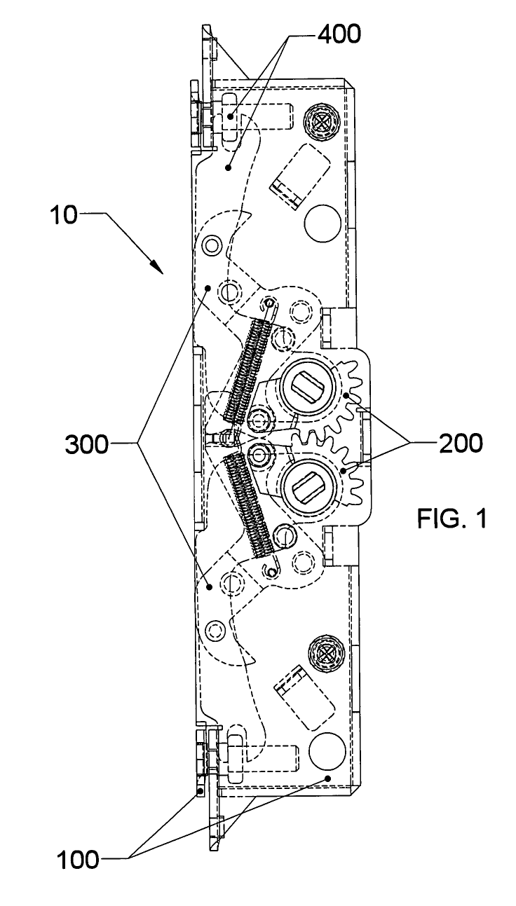

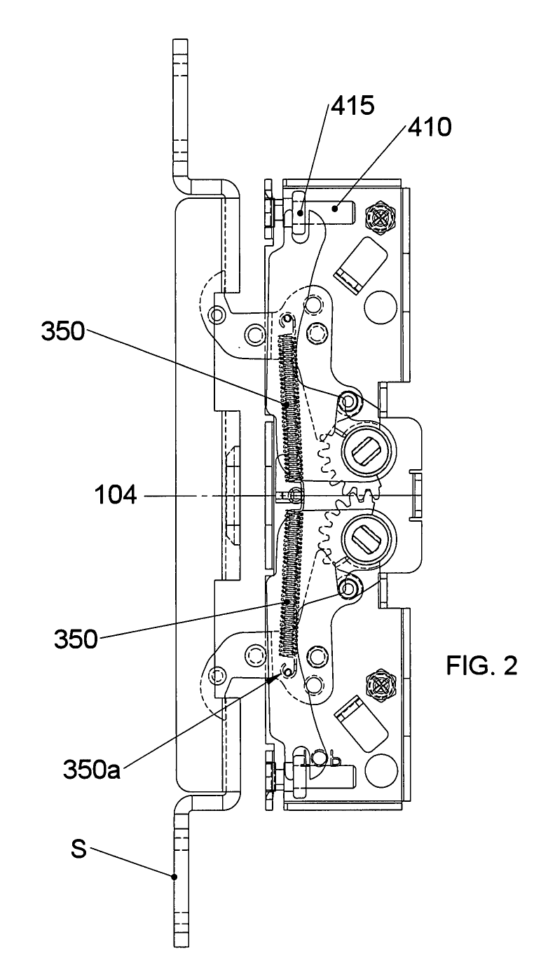

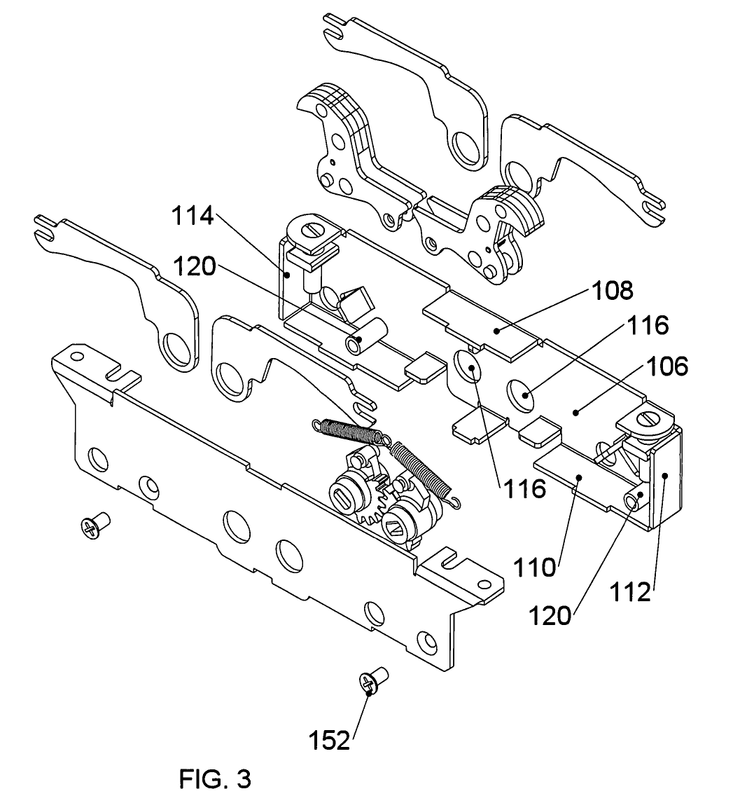

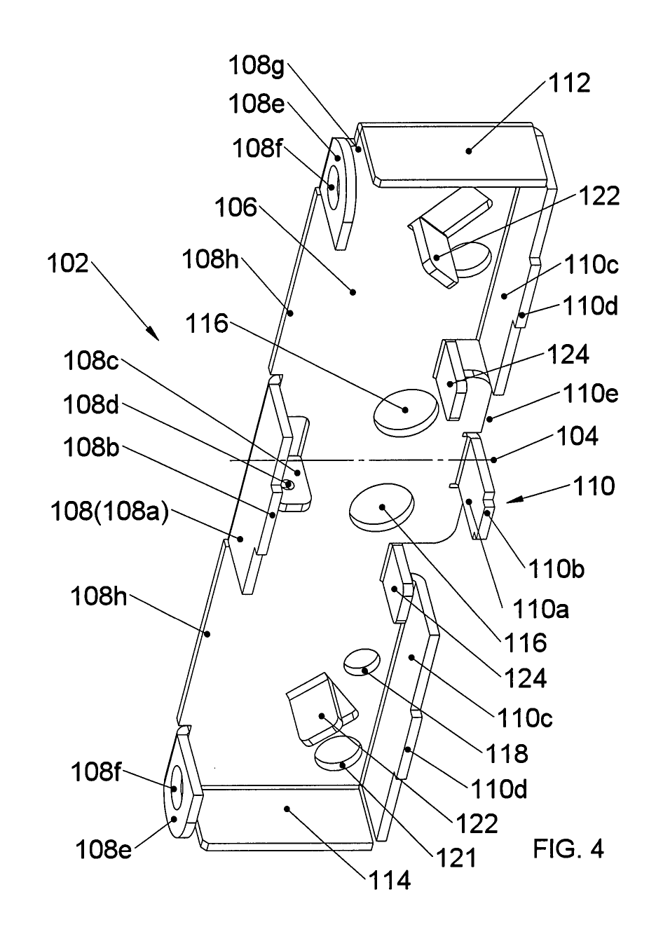

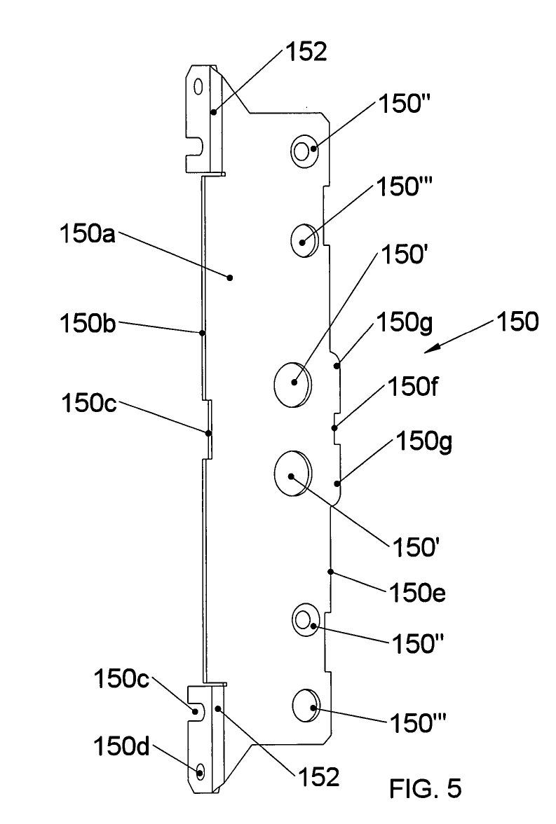

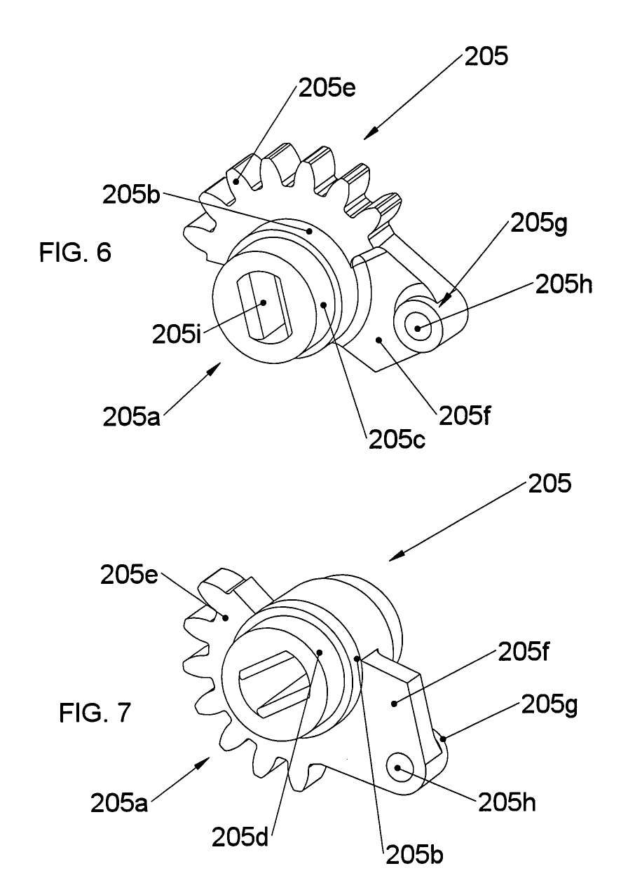

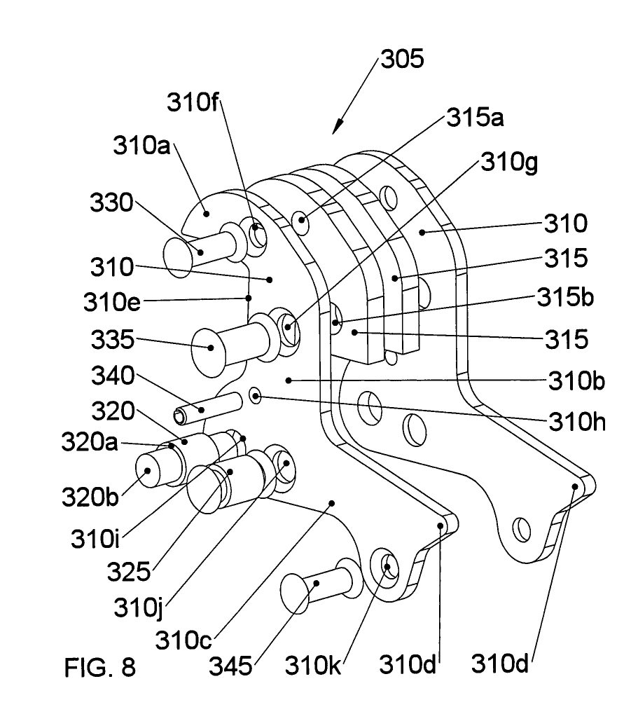

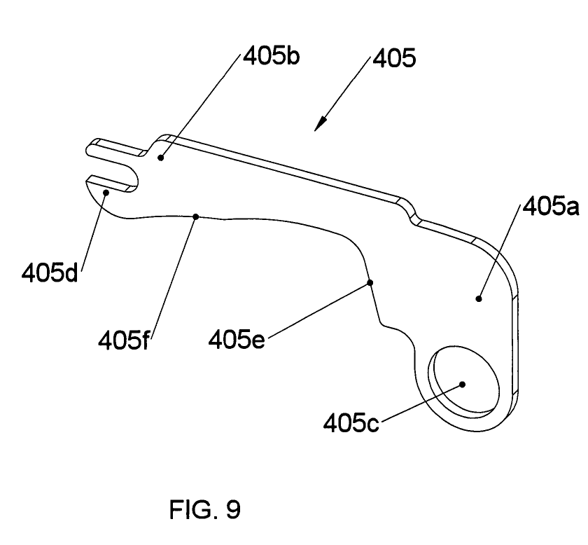

When a user inadvertently tries to slam shut a door with outwardly extending hook sections 310 in a protruded state as in the locked position, i.e. the latter being out of elongated housing 102 through its open spaces 108f, outwardly extending hook sections 310a will be subjected to an impact (impact exceeding a preestablished magnitude) against an encountered external object, for example a strike plate S, specifically against zones between the apertures of the latter. To prevent an expected damage of outwardly extending hook sections 310, dual-hook locking assembly 10 designed according to the present invention is anti-slam protected. Thus, as the door moves toward closing, while outwardly extending hook sections 310a impact against an encountered external object, a continued closing movement of the door causes an inward movement of outwardly extending hook sections 310a. As a result, middle sections 310b of the pair of long external hook plates 310, which are components of hook mechanisms 305, press against and are stopped by their associated stop lugs 122. Upper stop lug 122 imparts a downward force to one hook mechanism 305 (the upper one), and/or lower stop lug 122 imparts an upward force to the other hook mechanism 305 (the lower one). Thus, while outwardly extending hook sections 310a retract into elongated housing 102, each hook mechanism 305 together with its associate pivoting body 205, without being damaged, are biased under the action of their corresponding helical tension spring 350 into their unlocked positions as illustrated in FIG. 1.

Anchor-cam wall 108c is engaged and supports at one side contacting lobes 310d of long external hook plates 310 of one hook mechanism 305 (the upper one) and at the other side is engaged and supports contacting lobes 310d of long external hook plates 310 of another hook mechanism 305 (the lower one). Due to the foregoing condition, a retractile movement of hook mechanism within casing subassembly 100 is achievable. The anchor-cam wall 108c fulfils the same role of engaging and support of contacting lobes 310d when a user starts changing the unlocked position into a locked position. Two engaging lugs 124 serve as stops for limiting the movement of the hook mechanisms 305 and of interconnected with them segmental gears 205e, beyond an established position, during the unlocking operation.

As required, a detailed embodiment of the present invention is disclosed herein; however, it is to be understood that the disclosed embodiment is merely exemplary of the invention which may be embodied in various forms. Therefore, specific structural and functional details disclosed herein are not to be interpreted as limiting, but merely as a basis for the claims and as representative basis for teaching one skilled in the art to variously employ the present invention in virtually any appropriately detailed structure.

What we claim is:

1. A dual-hook locking assembly comprising in combination
means for housing wherein are mounted gearing means for operating;
means for locking operated between a locked position and an unlocked position by said gearing means for operating; and
means for adjusting said means for locking in a convenient position with respect to a strike plate;
said means for housing comprising an elongated housing and a closing plate, the former and the latter being assembled together;
said gearing means for operating including a pair of pivoting bodies, each one of the latter incorporating a segmental gear, an actuation of one of said pivoting bodies transmits a rotation via its said segmental gear to the other said segmental gear, the former meshing with the latter; each one said pivoting bodies incorporating as well a tail element situated in a zone adjacent to said segmental
gear and provided with perpendicular opening means for insertion of a connecting feature;
said means for locking comprising a pair of hook mechanisms, each of the latter having an outwardly extending hook section, a middle section and an inwardly extending connecting section extending towards the transversal axis of symmetry of said means for housing, said inwardly extending connecting section including a contacting lobe and a hole, located in a zone adjacent to the latter for coinciding with said perpendicular opening means for insertion, and penetrated by said connection feature, thus a direct pivoting interconnection between said gearing means for operating, respectively each said tail element of each of said pivoting bodies and said means for locking, each of the latter having an aperture in its said middle section penetrated by a pin protruding outwardly, beyond said means for locking, as adjusting butts;
at least one tension springy element for connecting said hook mechanisms via an anchor-cam wall coplanar with said transversal axis of symmetry and disposed perpendicularly to a central front wall of said elongated housing,
said at least one tension springy element for connecting said hook mechanisms developing a return force from its extended position when said hook mechanisms are in their latching position, and resiliently keep said hook mechanisms when they are in retracted, unlocked position; and said means for adjusting said means for locking in a convenient position with respect to a strike plate including two pairs of guiding plates, each pair of the latter being able to turn with its inwardly extending ends around one of said pivoting bodies and interact with one of said hook mechanisms, while its outwardly extending ends are associated with an adjusting bolt-nut.

2. The dual-hook locking assembly, as defined in claim 1, wherein, for anti-slam protection, said elongated housing is provided with two stop lugs, an upper and a lower struck from a lateral main wall of said elongated housing, inclined with respect to said transversal axis of symmetry and disposed relatively closer to a back wall; one said stop lug being situated in the proximity of a top wall, while the other one—in a proximity of a bottom wall; when a user inadvertently tries to slam shut a door with said outwardly extending hook sections in a protruded state as in the locked position, i.e. the latter being out of said elongated housing through its open spaces, said outwardly extending hook sections will be subjected to an impact (impact exceeding a preestablished magnitude) against an encountered external object, a continued closing movement of the door causes an inward movement of said outwardly extending hook sections, and as a result, said middle sections press against and are stopped by said stop lugs, said upper stop lug imparting a downward force to one of said hook mechanisms (the upper one), and/or said lower stop lug imparting an upward force to said other hook mechanism (the lower one), thus, said outwardly extending hook sections retract into said elongated housing, each said hook mechanism together with its associate pivoting body, without being damaged, are biased under the action of said at least one tension springy element into their unlocked positions.
